(19) United States
(12) Patent Application Publication
(10) Pub. No.: US 2025/0322613 A1
(43) Pub. Date: Oct. 16, 2025

(54) METHODS AND SYSTEMS FOR DETERMINING ALTERNATIVE INCISAL VIEW

(71) Applicant: Align Technology, Inc., San Jose, CA (US)

(72) Inventors: Mikhail IUDASHKIN, Madrid (ES); Pavel FANASKOV, Moscow (RU); Arkadiy SOKOLOV, Cary, NC (US); Maria Elena Azanero ROSALES, Valdemoro (ES); Daria GOROKHOVA, Moscow (RU); Aleksandr ZLENKO, Pushkino M.O. (RU)

(21) Appl. No.: 19/177,444

(22) Filed: Apr. 11, 2025

Related U.S. Application Data
(60) Provisional application No. 63/633,047, filed on Apr. 11, 2024.

(51) Int. Cl. G06T 19/00; A61C 7/00; A61C 9/00; A61C 13/34

(52) U.S. Cl. CPC G06T 19/00; A61C 7/002; A61C 9/0053; A61C 13/34; G06T 2200/24; G06T 2210/12

(57) ABSTRACT

System, methods, and apparatus for displaying alternative incisal views of a patient's three-dimensional (3D) digital model are disclosed. An incisal view may include maximal portions of labial, lingual, and occlusal incisor tooth surfaces. Some methods may include accessing the 3D digital model of the patient's upper or lower dental arch, optimizing a virtual camera position relative to the 3D digital model to generate the incisal view having a maximized view of an occlusal surface, a lingual side, and a labial side and generating the incisal view based on the optimized virtual camera position.

### CLAIM OF PRIORITY

This patent application claims priority to U.S. Provisional Patent Application No. 63/633,047, filed on Apr. 11, 2024, titled “METHODS AND SYSTEMS FOR DETERMINING ALTERNATIVE INCISAL VIEW,” and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

The systems and methods described herein relate generally to analysis of dental images, and more particularly to the determination and viewing of alternate views of three-dimensional dental models corresponding to a dental treatment plan.

### BACKGROUND

Orthodontic and dental treatments using a series of patient-removable appliances (e.g., “aligners”) are very useful for treating a variety of patients. Treatment planning is typically performed in conjunction with the dental professional (e.g., dentist, orthodontist, dental technician, etc.), by manipulating a model of the patient's teeth from an initial configuration (initial tooth positions) to a final configuration (final tooth positions) and then dividing the treatment into a number of intermediate stages (steps). These steps may correspond to individual appliances that may be worn sequentially, with or without additional interventions (e.g., interproximal reductions, extractions, etc.). Once the treatment plan is finalized, the series of aligners may be manufactured corresponding to the treatment plan.

The treatment plan may begin with a dental scan of the patient's dentition. The dental scan can be the basis of the treatment plan and a three-dimensional model of the patient's teeth may be generated as part of the treatment plan. In some examples, the aligners may be manufactured using information from the three-dimensional model.

Visualization of the three-dimensional models that correspond to the treatment plan may enable the orthodontist or other clinician to fine-tune and approve the dental treatment plan. Conventional views of the three-dimensional models may occlude some dental features or otherwise make the inspection of the patient's dental arch, and therefore approval of the dental treatment plan, difficult.

### SUMMARY OF THE DISCLOSURE

Described herein are apparatuses, systems, and methods for generating different views of a patient dental arch. In particular, various apparatuses, systems, and methods enable a user (dentist, orthodontist, or other clinician) to inspect conventional and alternate views of a patient's tooth positions, as predicted according to a dental treatment plan. The alternate view, sometimes referred to as an incisal view, can show labial, occlusal, and lingual incisor surfaces that may not be shown in conventional views. The incisal view may enable the user to review results of a treatment plan from a different angle. The incisal view may enable the user to better view treatment plan results, which can provide better outcomes for the patient.

In some examples, various views of the patient's teeth may be generated based on a position of a virtual camera. Graphical elements (various portions of the patient's three-dimensional (3D) digital dental model) that are within the virtual camera's field of view are included in a view based on the position of the virtual camera. The relationship between the virtual camera and the 3D digital dental model can affect how the patient's teeth can appear. In some implementations, the alternate view can be generated by changing a position of the virtual camera with respect to the 3D digital dental model. In some cases, the position of the virtual camera can be based on one or more incisors that are included within the patient's dental arch as well as whether the dental arch is an upper dental arch or a lower dental arch.

Any of the systems described herein may include a processor that is configured to access a 3D digital model of a patient's upper or lower dental arch, optimize a virtual camera position relative to the 3D digital model to generate an incisal view having a maximized view of an occlusal surface, a lingual side, and a labial side or each incisor in the 3D digital model, and generate the incisal view of the 3D digital model based on the optimized virtual camera position.

In any of the systems described herein, the processor may be configured to optimize the virtual camera position based on a bounding box that surrounds the patient's upper or lower dental arch, wherein the incisal view of the 3D digital model of the patient's dental arch includes all of the bounding box. In general, including the bounding box within a view can control or determine the field of view any displayed image. In some examples, the processor may be further configured to calculate the average orientation of each incisor from an individual orientation of each incisor estimated for each incisor as an axis projected from a root of each incisor. In some other examples, the processor may be further configured calculate the average orientation of each incisor from an individual orientation of each incisor estimated for each incisor as an axis projected from a center of an incisor to a peak of an occlusal edge of the incisor from the 3D digital model. In some aspects, the center of the incisor comprises the center of mass of the incisor from the 3D digital model.

In any of the systems described herein, the 3D digital model may be based on (for example, derived from) an intraoral scan of the patient's teeth. In some examples, the 3D digital model can include a predicted configuration of teeth in accordance with a treatment plan for the patient.

In any of the systems described herein, the processor may be further configured to: determine a central point of the patient's dental arch and tilt the virtual camera toward the central point by a predetermined amount. In general the predetermined amount may be range limited and empirically derived. In some examples, the predetermined amount may be between approximately 5 and 15 degrees. In some other implementations, the predetermined amount can be between about 5-9 degrees when the dental arch is a lower dental arch and between about 9-12 degrees when the dental arch is an upper dental arch.

In any of the systems described herein, the processor may be configured to optimize the virtual camera position based on one or more incisors missing from the 3D digital model of the patient's dental arch.

In any of the systems described herein, the processor may be further configured to cause the incisal view to be displayed. In many cases, the system may include or be coupled to a display or user interface that includes a display element. The processor may cause the incisal view and/or a conventional view to be displayed.

In any of the systems described herein, may include a user interface configured to detect an incisal view selection input from a user. In some examples, the user interface may be configured to display a view of the 3D digital model. In general, the view may be the incisal view or a conventional view. In some implementations, the detected incisal view selection input comprises a user selecting a virtual control on the user interface.

In any of the systems described herein, the processor may be further configured to access the 3D digital model of the patient's upper or lower dental arch in response to a detection of an incisal view selection input.

Any of the non-transitory computer-readable storage mediums described herein may include instructions that, when executed by one or more processors of a device, cause the device to perform operations including accessing a three-dimensional (3D) digital model of a patient's upper or lower dental arch, optimizing a virtual camera position relative to a, a three-dimensional (3D) digital model of a patient's dental arch to generate an incisal view having a maximized view of an occlusal surface, a lingual side and labial side of each incisor in the 3D digital model, and generating the incisal view of the 3D digital model based on the optimized virtual camera position.

Any of the methods described herein may include accessing a three-dimensional (3D) digital model of a patient's upper or lower dental arch, optimizing a virtual camera position relative to a, a three-dimensional (3D) digital model of a patient's dental arch to generate an incisal view having a maximized view of an occlusal surface, a lingual side and labial side of each incisor in the 3D digital model, and generating the incisal view of the 3D digital model based on the optimized virtual camera position.

As used herein, optimizing the virtual camera angle may include positioning of the camera so that a maximum amount of the patient's dental arch is included in the field of view (e.g., optimizing based on the amount of the dental arch in the field of view), and/or so that a maximum amount of the incisors are included in the field of view. In some cases the teeth may be identified (e.g., by segmentation) and the visible areas corresponding to occlusal surface (based on the amount or percent of the occlusal surface visible) may be optimized for different camera positions.

For example, the methods may include optimizing the virtual camera position based on a bounding box that surrounds the patient's upper or lower dental arch, wherein the incisal view of the 3D digital model of the patient's dental arch includes all of the bounding box. The method may include optimizing the virtual camera position based on an average orientation of each incisor in the 3D digital model. In some cases the method may include calculating the average orientation of each incisor from an individual orientation of each incisor estimated for each incisor as an axis projected from a root of each incisor. The method may include calculating the average orientation of each incisor from an individual orientation of each incisor estimated for each incisor as an axis projected from a center of an incisor to a peak of an occlusal edge of the incisor from the 3D digital model. As mentioned, the center of the incisor may comprise the center of mass of the incisor from the 3D digital model.

Any of these methods may include optimizing the virtual camera position based on an average orientation of each incisor in the 3D digital model. The 3D digital model may be based on an intraoral scan of the patient's teeth. In some cases the 3D digital model is based on a segmented intraoral scan of the patient's teeth. The method may include comparing the 3D digital model to a predicted configuration of teeth in accordance with a treatment plan for the patient.

Any of these methods may include determining a central point of the patient's dental arch and tilting the virtual camera toward the central point by a predetermined amount (e.g., the predetermined amount may be between about 2 and 25 degrees, between about 3 and 20 degrees, between about 5 and 15 degrees, etc.). The predetermined amount may be based on whether the dental arch is the patient's upper or lower dental arch. In some cases the predetermined amount is between about 2-12 degrees (e.g., about 3-10 degrees, about 5-9 degrees, etc.) when the dental arch is a lower dental arch and between about 6-20 degrees (e.g., about 7-18 degrees, about 8-15 degrees, about 9-12 degrees, etc.) when the dental arch is an upper dental arch.

The method may include optimizing the virtual camera position based on one or more incisors missing from the 3D digital model of the patient's dental arch. The method may include displaying the incisal view, and/or detecting an incisal view selection input from a user. The method may include displaying the view of the 3D digital model in a user interface.

Any of these methods may include selecting a virtual control on the user interface (e.g., to detect incisal view selection input).

The method may include accessing the 3D digital model of the patient's upper or lower dental arch in response to a detection of an incisal view selection input.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is a diagram illustrating one variation of a dental computing environment.

FIG. 2 is a block diagram of one example of treatment planning visualization module.

FIG. 3 shows a diagram describing possible views of a patient's 3D digital model.

FIG. 4 shows example views of a 3D digital model of the patient's dental arch in accordance with this disclosure.

FIG. 5 is a simplified diagram showing differences between a conventional view of a patient's dental arch and an incisal view of the patient's dental arch.

FIG. 6 is a flowchart showing an example method for determining an incisal view.

FIG. 7 shows an example user interface.

FIG. 8 shows another example user interface.

FIG. 9 shows a block diagram of a device that may be one example a device configured to perform one or more operations associated with the computing environment of FIG. 1.

### DETAILED DESCRIPTION

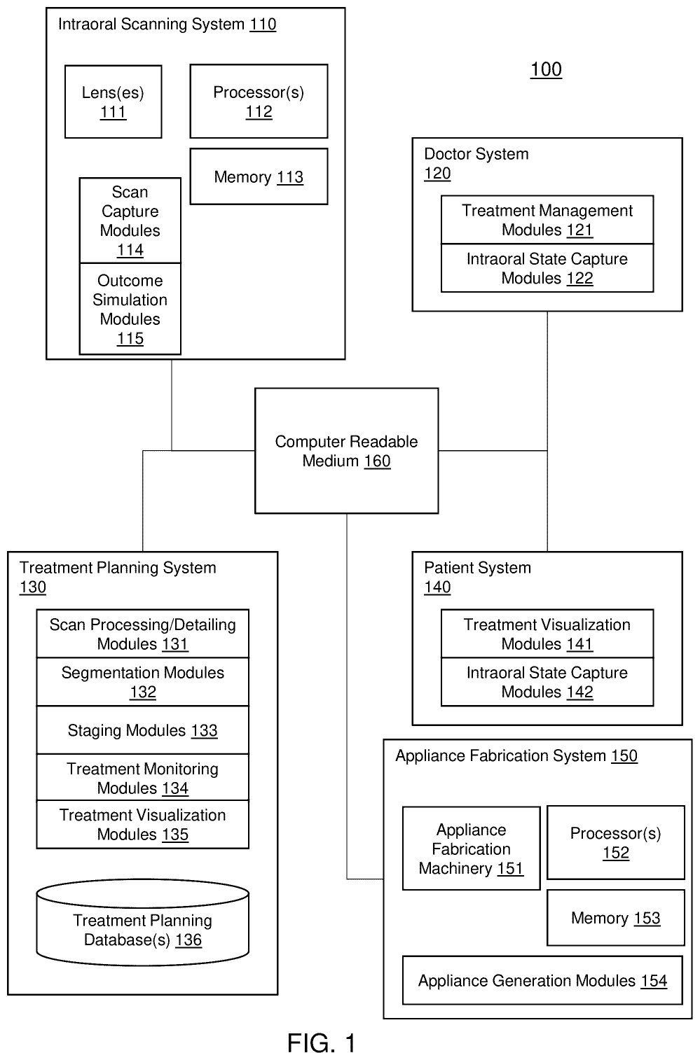

In general, these methods and apparatuses may be used at one or more parts of a dental computing environment, including as part of an intraoral scanning system, doctor system, treatment planning system, patient system, and/or fabrication system. In particular, these methods and apparatuses may be used as part of a treatment planning system, for example, to determine an accurate (in some cases initial) location of a patient's teeth. The initial location may be used to determine a final location for one or more of the patient's teeth based on a treatment plan. The treatment plan may be optimized (modified) based on updated dental scans. For example, FIG. 1 is a diagram illustrating one variation of a dental computing environment 100 that may generate one or more orthodontic treatment plans specific to a patient, and fabricate dental appliances that may accomplish the treatment plan to treat a patient, under the direction of a dental professional. The example dental computing environment 100 shown in FIG. 1 includes an intraoral scanning system 110, a doctor system 120, a treatment planning system 130, a patient system 140, an appliance fabrication system 150, and computer-readable medium 160. In some variations the dental computing environment (sometimes referred to as a dental computing system) 100 may include just one or a subset of these systems (which may also be referred to as sub-systems of the overall system 100). Further, one or more of these systems may be combined or integrated with one or more of the other systems (sub-systems), such as, e.g., the treatment planning system 130 and the doctor system 120 may be part of a remote server accessible by a doctor interface. The computer-readable medium 160 may divided between all or some of the systems (subsystems); for example, the treatment planning system 130 and the appliance fabrication system 150 may be part of the same sub-system and may be on a computer-readable medium 160. Further, each of these systems may be further divided into sub-systems or components that may be physically distributed (e.g., between local and remote processors, etc.) or may be integrated.

An intraoral scanning system may include an intraoral scanner as well as one or more processors for processing images. For example, the intraoral scanning system 110 can include lens(es) 111, processor(s) 112, a memory 113, scan capture modules 114, and outcome simulation modules 115. In general, the intraoral scanning system 110 can capture one or more images of a patient's dentition. Use of the intraoral scanning system 110 may be in a clinical setting (doctor's office or the like) or in a patient-selected setting (the patient's home, for example). In some cases, operations of the intraoral scanning system 110 may be performed by an intraoral scanner, dental camera, cell phone or any other feasible device.

The lens(es) 111 include one or more lenses and optical sensors to capture reflected light, particularly from a patient's dentition. The scan capture modules 114 can include instructions (such as non-transitory computer-readable instructions) that may be stored in the memory 113 and executed by the processor(s) 112 to control the capture of any number of images of the patient's dentition.

As mentioned, in some examples the methods and apparatuses described herein for generating a 3D digital model including one or more teeth may be part of, or accessible by, the intraoral scanning system 110, computer-readable medium 160 and/or treatment planning system 130.

For example, the outcome simulation modules 115, which may be part of the intraoral scanning system 110, can include instructions that simulate final tooth positions (e.g., a predicted configuration of teeth) based on a treatment plan. In some cases, the outcome simulation modules 115 can include instructions that simulate tooth positions using images or other scan data from a dental scan.

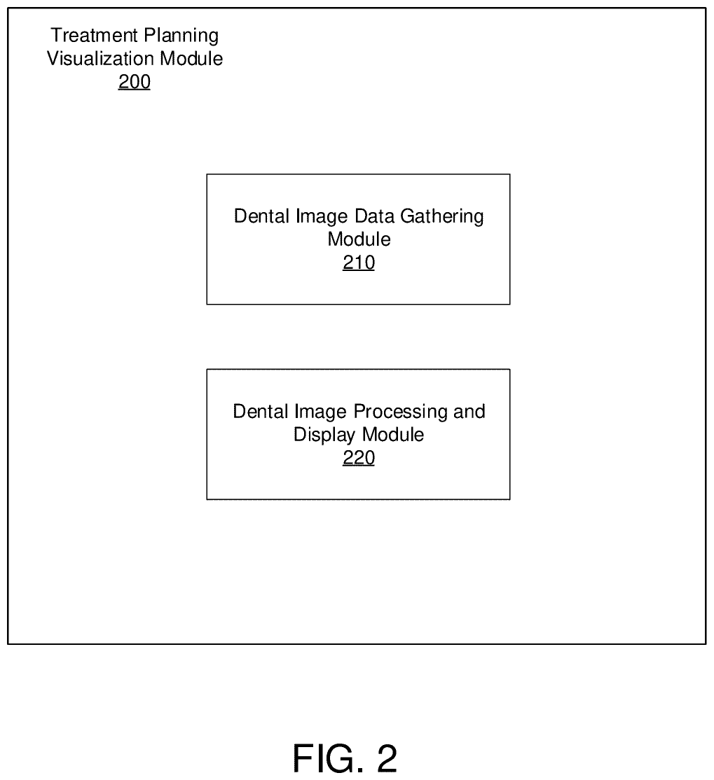

Any of the component systems or sub-systems of the dental computing environment 100 may access or use the patient's dental information including scan data, three-dimensional (3D) dental models, and/or treatment plans generated by the methods and apparatuses described herein. For example, the doctor system 120 may include treatment management modules 121 and intraoral state capture modules 122 that may access or use patient scan data and/or 3D dental models. The doctor system 120 may provide a “doctor facing” interface to the computing environment 100. The treatment management modules 121 can perform any operations that enable a doctor or other clinician to manage the treatment of any patient. In some examples, the treatment management modules 121 may provide a visualization and/or simulation of the patient's dentition with respect to a treatment plan. For example, the doctor system 120 may include a user interface for the doctor that allows the doctor to manipulate and view a patient's 3D dental model, including a 3D dental model corresponding to a final position of teeth in accordance with the treatment plan. More details regarding the generation of a view of the patient's 3D dental model is described herein with respect to FIG. 2.

The intraoral state capture modules 122 can provide images of the patient's dentition to a clinician through the doctor system 120. The images may be captured through the intraoral scanning system 110 and may also include images of a simulation of tooth movement based on a treatment plan.

In some examples, the treatment management modules 121 can enable the doctor to modify or revise a treatment plan. The doctor system 120 may include one or more processors configured to execute any feasible non-transitory computer-readable instructions to perform any feasible operations described herein.

Alternatively or additionally, the treatment planning system 130 may include any of the methods and apparatuses described herein, and/or may determine a mapping between dental scans of a patient that are displaced in time. The treatment planning system 130 may include scan processing/detailing modules 131, segmentation modules 132, staging modules 133, treatment monitoring modules 134, treatment visualization modules 135, and treatment planning database(s) 136. In general, the treatment planning system 130 can determine a treatment plan for any feasible patient. The scan processing/detailing modules 131 can receive or obtain dental scans (such as scans from the intraoral scanning system 110) and can process the scans to “clean” them by removing scan errors and, in some cases, enhancing details of the scanned image.

The treatment planning system 130 may include a segmentation system that segments a model into separate components. For example, the treatment planning system 130 may include a segmentation modules 132 that can segment a dental model (such as a 3D dental model) into separate parts including separate teeth, gums, jaw bones, and the like. In some cases, the dental models may be based on scan data from the scan processing/detailing modules 131.

The staging modules 133 may determine different stages of a treatment plan. Each stage may correspond to a different dental aligner. In some examples, the staging modules 133 may also determine the final position (also referred to as target position) of the patient's teeth, in accordance with a treatment plan. Thus, the staging modules 133 can determine some or all of a patient's orthodontic treatment plan. In some examples, the staging modules 133 can simulate movement of a patient's teeth in accordance with the different stages of the patient's treatment plan.

The treatment monitoring modules 134 can monitor the progress of an orthodontic treatment plan. In some examples, the treatment monitoring modules 134 can provide an analysis of progress of treatment plans to a clinician. The orthodontic treatment plans may be stored in the treatment planning database(s) 136. Although not shown here, the treatment planning system 130 can include one or more processors configured to execute any feasible non-transitory computer-readable instructions to perform any feasible operations described herein.

The treatment visualization modules 135 can perform any operations that enable a doctor or other clinician to visualize the treatment plan of any patient. In some examples, the treatment visualization modules 135 may provide a visualization and/or simulation of the patient's dentition with respect to a proposed treatment plan. For example, the treatment planning system 130 may include a user interface that allows the doctor to manipulate and/or view a patient's 3D dental model, including a 3D dental model corresponding to a final position of teeth in accordance with the treatment plan. More details regarding the generation of a view of the patient's 3D dental model is described herein with respect to FIG. 2.

The patient system 140 can include treatment visualization modules 141 and intraoral state capture modules 142. In general, the patient system 140 can provide a “patient facing” interface to the computing environment 100. The treatment visualization modules 141 can enable the patient to visualize how a orthodontic treatment plan has progressed and also visualize a predicted outcome (e.g., a final position of teeth).

In some examples, the patient system 140 can capture dentition scans for the treatment visualization modules 141 through the intraoral state capture modules 142. The intraoral state capture modules 142 can enable a patient to capture his or her own dentition through the intraoral scanning system 110. Although not shown here, the patient system 140 can include one or more processors configured to execute any feasible non-transitory computer-readable instructions to perform any feasible operations described herein.

The appliance fabrication system 150 can include appliance fabrication machinery 151, processor(s) 152, memory 153, and appliance generation modules 154. In general, the appliance fabrication system 150 can directly or indirectly fabricate aligners to implement an dental treatment plan. In some examples, the dental treatment plan may be stored in the treatment planning database(s) 136.

The appliance fabrication machinery 151 may include any feasible implement or apparatus that can fabricate any suitable dental aligner. The appliance generation modules 154 may include any non-transitory computer-readable instructions that, when executed by the processor(s) 152, can generate one or more design files that can correspond to stages determined by the staging modules 133. In turn, the one or more design files may be used to build or fabricate one or more dental aligners. In some examples, the appliance fabrication machinery 151 can use the design files to produce the one or more dental aligners. The memory 153 may store data or instructions for use by the processor(s) 152. In some examples, the memory 153 may temporarily store a treatment plan, dental models, or intraoral scans.

The computer-readable medium 160 (sometimes referred to as a non-transitory computer-readable storage medium) may include some or all of the elements described herein with respect to the dental computing environment 100. The computer-readable medium 160 may include non-transitory computer-readable instructions that, when executed by a processor, can provide the functionality of any device, machine, or module described herein.

FIG. 2 is a block diagram of one example of a treatment planning visualization module 200. The treatment planning visualization module 200 may be wholly or partially included within the treatment management modules 121 and/or the treatment visualization modules 135 of FIG. 1. The treatment planning visualization module 200 may include a dental image data gathering module 210, and a dental image processing and display module 220. In general, the treatment planning visualization module 200 can generate one or more views of a 3D dental model that correspond to predicted final tooth positions based on a dental treatment plan. In some examples, the generated views may be based on an optimized or alternate virtual camera position. This camera position may enable the viewing or inspection of characteristics of the 3D digital model that were previously occluded in other (in some cases conventional) views.

Notably, the operations performed by, or associated with the treatment planning visualization module 200 provide a technical solution to a technical problem. Generating a view of a 3D dental model is a technical problem rooted in computer technology. Generating a view of the 3D dental model that maximizes the visibility of labial, occlusal, and/or lingual tooth surfaces is a technical problem with comparatively more difficulty. In most instances, it may be difficult and/or impossible to find a view of the 3D dental model that maximizes the visibility of labial, occlusal, and/or lingual tooth surfaces that is not time consuming or labor intensive. In addition, the technical solution provided by the treatment planning visualization module 200 may provide a solution that is sufficiently efficient, particularly compared to a “brute force” method for maximizing the visibility of labial, occlusal, and/or lingual tooth surfaces.

The operations described herein provide a solution for a problem rooted in computer technology to overcome a problem specifically associated with displaying information and/or images through a graphical user interface.

The dental image data gathering module 210 can receive or obtain a patient's dental image data. The dental image data may include 3D dental model data of a patient's upper and/or lower dental arches. In some examples, the dental image data may be associated with a dental treatment plan and, in some cases, the dental image data may be associated with the final position of the patient's teeth according to a dental treatment plan. In some other examples, the dental image data gathering module 210 may cause the patient's dental image data to be generated.

The dental image processing and display module 220 can process the dental image data (from the dental image data gathering module 210) so that a suitable 3D dental image can be displayed. The dental image processing and display module 220 can also display 3D dental images on a display, user interface or other suitable device.

The dental image processing and display module 220 can select or optimize a position of a virtual camera used to determine a view of the 3D dental image. The position of the virtual camera can affect the features of the dental images which can be seen or occluded. In some cases, the position of the virtual camera can determine when a maximal amount of labial, occlusal (occlusal edge), and/or lingual tooth surfaces can be visible in any view. In some examples, the dental image processing and display module 220 can automatically determine or generate a view of the 3D dental image that includes a maximal amount (a maximized view) of visible labial, occlusal, and/or lingual tooth surfaces. In some other examples, the dental image processing and display module 220 can determine a conventional 3D dental image view or an alternative 3D dental image view that includes labial, occlusal, and/or lingual tooth surfaces.

In some examples, the dental image processing and display module 220 may include a user interface. The user interface can include a display that is used to display views of the 3D dental model to the doctor, clinician, or patient. In addition, the user interface may include a control surface that can interact with and receive inputs from a user. For example, the user interface may display selection choices (on a display, touch screen or the like) with which the user can select one or more choices. Through the control surface, the user may select the display of conventional or alternate views of the dental arch.

The embodiments described herein may be used to determine or generate a view of the 3D digital model of a patient's dental arch. The generated view may be optimized in order to show tooth surfaces that may be hidden, occluded, or minimally shown with respect to conventional views. The generated view may enable a dentist, technician, or the like to more easily perform an assessment of a dental treatment plan.

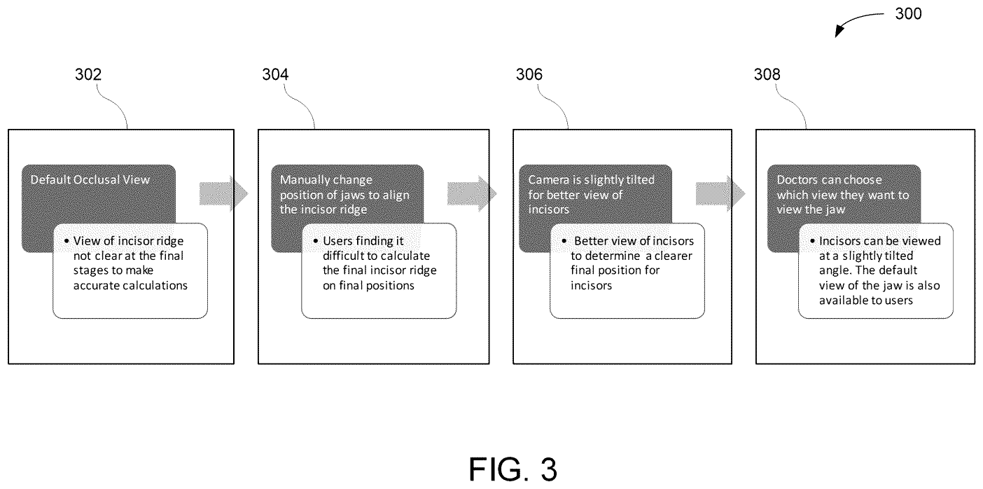

FIG. 3 shows a diagram 300 describing possible views of a patient's 3D digital model. At block 302 a default occlusal view of a 3D digital model of a patient's dental arch may be shown. The view of the dental arch may be associated with the final position of the patient's teeth according to a dental treatment plan. The default occlusal view may be a conventional view of the patients teeth. For example, the conventional view may show a view of the occlusal (chewing) surfaces of the teeth, particularly the molars. In some cases, however, the default occlusal view may not clearly show a view of the incisor ridge. In many cases, the default occlusal view would fail to show labial and/or lingual tooth surfaces, especially of incisor teeth.

At block 304, a user may try to manually change the virtual jaw position(s) to provide a different view of the 3D digital model of the patient's dental arch. The different view may show a better view of incisor ridges. In order to generate the different view, a positional relationship between a virtual camera and the 3D digital model could be changed or modified. Users may find that manually determining a new or modified relationship between the virtual camera and the 3D digital model may involve difficult and/or tedious calculations.

At block 306, the camera is repositioned (in some cases virtually tilted) to provide a different view of the 3D digital model of the patient's dental arch. In some examples, the camera may be repositioned to a predetermined alternative position that may be empirically determined. The repositioned camera may provide a better and/or preferred view of incisor teeth. This view may show labial and lingual surfaces of the incisor teeth. In some examples, the views of the incisor teeth may have a maximal amount of labial and lingual surfaces. The views of the 3D digital model associated with block 306 may provide a better view of the incisors (compared to the default or conventional view of block 302). A view of the incisors that include labial and lingual surface may enable the dentist or clinician to more judge the effectiveness of a dental treatment plan.

At block 308, a dentist (or another clinician) can choose which view of the 3D digital model they want to view. For example, the dentist can view either the default occlusal view (of block 302) or the alternative view (of block 306). Some dentists may view both views in order to obtain a more comprehensive view of the final position of the teeth.

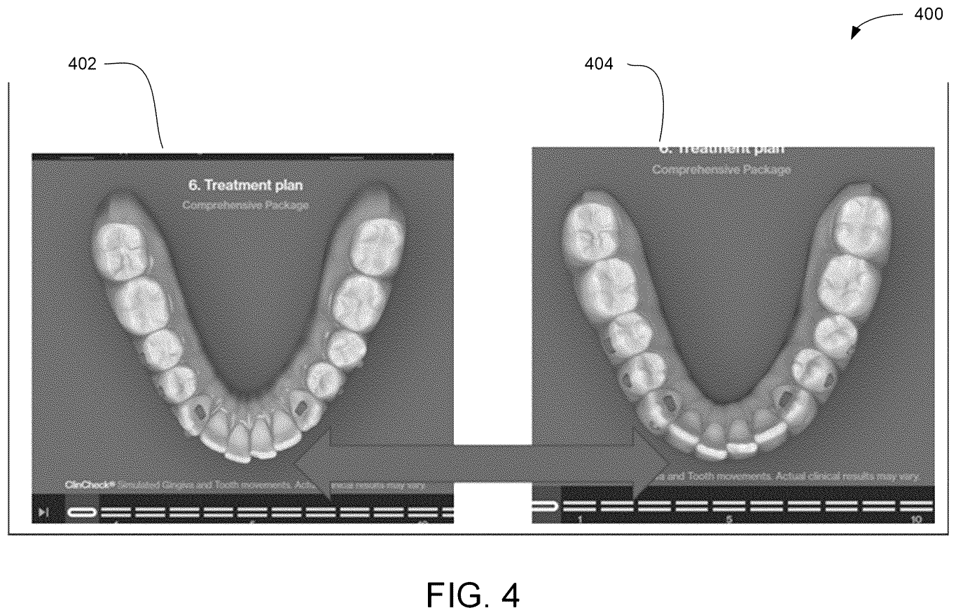

FIG. 4 shows example views 400 of a 3D digital model of the patient's dental arch in accordance with this disclosure. An example conventional or default occlusal view of the patient's dental arch is shown in view 402. Notably, the conventional or default occlusal view does not show any labial surfaces of the patient's incisor teeth. An alternative view of the patient's dental arch is shown in view 404. Both lingual and labial surfaces of the patient's incisor teeth are shown in view 404.

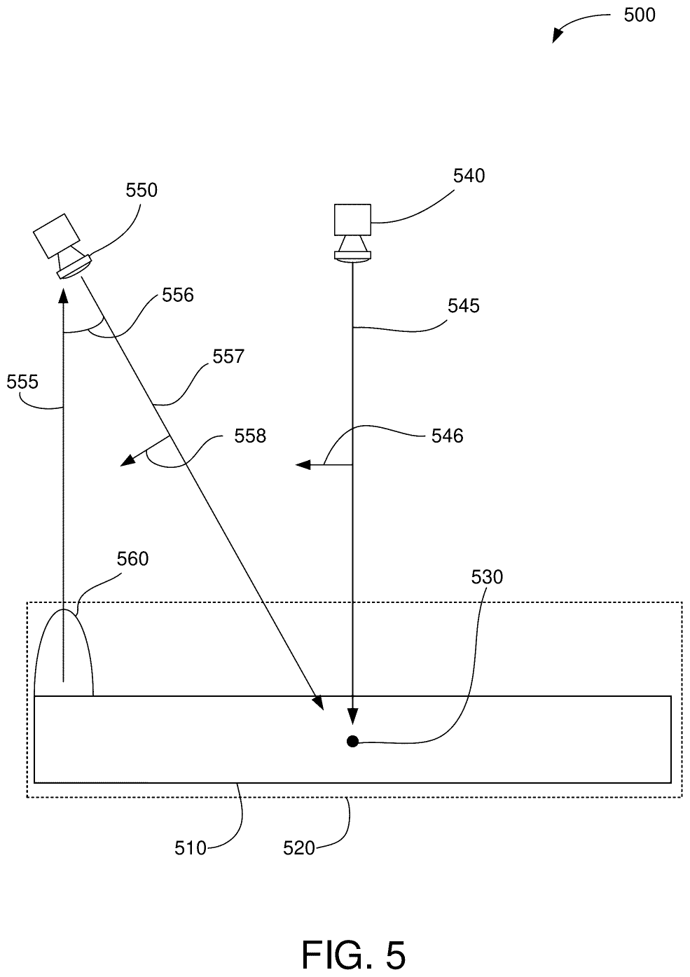

FIG. 5 is a simplified diagram 500 showing differences between a conventional view of a patient's dental arch and an incisal view of the patient's dental arch. In some examples, the incisal view may also be referred to as an anterior occlusal view. The patient's jaw or skull 510 is represented by a solid box. The jaw or skull 510 may be the bone structure that supports the patient's teeth. A bounding box 520 (shown in dotted lines) can include the bone structure (of 510) and also a 3D dental model of the patient's teeth associated with the jaw or skull 510. In some examples, the bounding box 520 can include a 3D dental model of the patient's upper dental arch or a lower dental arch in a final position in accordance with a dental treatment plan.

The bounding box 520 and/or the jaw or skull 510 may include a central point 530. The central point 530 may be an approximate geometric center of the jaw or skull 510. In some cases, the central point 530 can be an approximate geometric center of the patient's upper dental arch or lower dental arch associated with the jaw or skull 510.

A first virtual camera position 540 may be approximately over the central point 530, and in some examples positioned to be pointed downward toward the central point 530. As shown, the first virtual camera position 540 may be pointed along a line 545 from the central point 530 to the first virtual camera position 540. The first virtual camera position 540 may be associated with a conventional view of the patient's dental arch such as the view 402 of FIG. 4. The first virtual camera position 540 may provide a field of view (FOV) that can include all of the bounding box 520. In other words, the first virtual camera position 540 can allow all of the dental arch included within the bounding box 520 to be viewed. In some examples, a vector 546 may be used to orient or indicate a particular direction of the patient's dental arch. Thus, the vector 546 may be useful in determining a displayed view of the patient's dental arch.

A second virtual camera position 550 may be determined by incisors 560 of the dental arch included with the bounding box 520. In some examples, the second virtual camera position 550 may be generally centered over the incisors 560. In some implementations, the second virtual camera position 550 may be positioned over the incisors 560 based on a line 555 from the incisors 560 to the second virtual camera position 550.

In some examples, the line 555 can be based on an average orientation of one or more incisor teeth. In some implementations, the line 555 can be based on average position (arithmetic average) of incisor teeth on the respective dental arch. In some other examples, the line 555 can be based on an average of incisor positions while taking into account any missing incisors or pontics. For example, some incisors may be missing, extracted, or unerupted. In such cases, the line 555 may be determined based on the location of the existing incisors as well as the location of any missing incisors. In still other examples, the average orientation can be based on an individual orientation of each incisor estimated for each incisor as an axis (line 555) projected from a root of each incisor. In some variations, the average orientation can be based on an individual orientation of each incisor estimated for each incisor as an axis projected (line 555) from a center of an incisor to a peak of an incisal edge of the incisor from the 3D digital model. In some cases, the line 555 may be positioned or adjusted to compensate for typical asymmetrics associated with incisor teeth.

In another example, the line 555 may be based on a center of mass of the incisors 560. That is, the line 555 may be based on an average center of mass of the incisors 560 (both existing incisors as well as any missing incisors). In some other examples, the line 555 may be based on an average of root-to-ridge vectors (lines) associated with one or more incisors 560. In other words, an average of axes projected from roots through ridges of incisors may be used to determine line 555. In some cases, the incisors 560 may include four incisors. In some other examples, the incisors 560 may include two incisors, however, the incisors 560 may include any feasible number if incisors. In some implementations, the line 555 may be based on the ridges of one or more incisors 560.

The second virtual camera position 550 may be tilted toward the central point 530 along line 557. In some cases, the amount of tilt (e.g., tilt angle 556) may be a predetermined amount based on the dental arch included in the bounding box 520. For example, if the bounding box 520 includes an upper dental arch, then the tilt angle 556 may be between approximately nine and twelve degrees. If the bounding box 520 includes a lower dental arch, then the tilt angle 556 may be between approximately five and nine degrees. Other tilt angles not mentioned here are possible. In some examples, the tilt angle 556 may be determined empirically to provide a desired view of the incisors 560. For example, an empirical review of more than two thousand cases may be performed to determine feasible tilt angles. The second virtual camera position 550 may also provide a field of view (FOV) that can include all of the bounding box 520. In some examples, a vector 558 may be used to orient or indicate a particular direction of the patient's dental arch.

The view of the incisors 560 provided by the second virtual camera position 550 may provide labial, occlusal, and lingual views of the incisors 560. In some examples, the view of the incisors 560 may include a maximal amount of the labial and occlusal tooth surfaces.

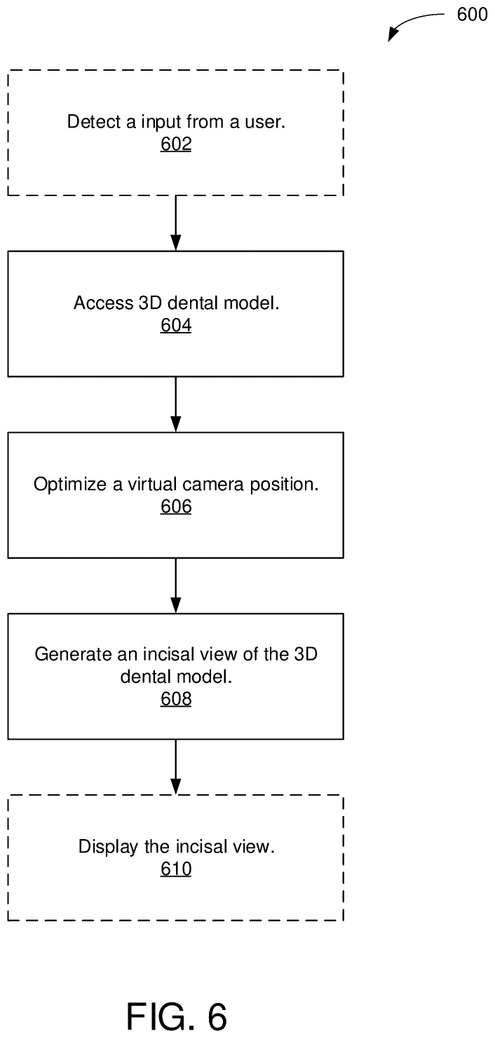

FIG. 6 is a flowchart showing an example method 600 for determining an incisal view. Some examples may perform the operations described herein with additional operations, fewer operations, operations in a different order, operations in parallel, and some operations differently. The method 600 is described below with respect to the system 100 of FIG. 1 and/or the treatment planning visualization module 200 of FIG. 2., however, the method 600 may be performed by any other suitable system or device.

The method 600 begins in block 602 as an input is detected from a user. For example, a user may interact with a user interface to select the generation of an incisal view of a 3D digital model of the patient's dentition. The detection of the input may be optional as depicted with dashed lines in FIG. 6. In some cases, the user may select that an alternative view of the patient's 3D dental model be generated and/or displayed. The alternative view may show labial, occlusal, and lingual surfaces of the patient's incisor teeth.

Next, in block 604, a 3D dental model of the patient's teeth is accessed. In some examples, the 3D dental model may include 3D digital models of the patient's teeth in a final position based on a dental treatment plan. Access of the 3D dental model may include receiving or obtaining the 3D dental model. In some examples, access of the 3D dental may include the generation of the patient's 3D dental model. The 3D dental model may be accessed in response to a detected user input. In some other examples, the 3D dental model may automatically be accessed independent of any user input. In some cases, accessing the 3D dental model may include the generation of the 3D dental model.

Next, in block 606, the position of the virtual camera is optimized. In some implementations, a virtual camera may be used to determine a point of view of an associated 2D, or 3D image. In block 606 an alternative (as opposed to a conventional) position of the virtual camera may be determined and/or optimized. For example, the position of the virtual camera may be determined in accordance with FIG. 5. Thus, the position of the virtual camera may be based on the location of one or more incisors in the dental arch of the patient.

In some examples, the position of the virtual camera may be above the incisors and tilted toward a central point of the patient's dental arch. In some cases, the amount of tilt may be determined by whether the dental arch to be displayed is an upper dental arch or a lower dental arch. A tilt angle of the virtual camera for an upper dental arch may be between approximately nine and twelve degrees. A tilt angle of the virtual camera for a lower dental arch may be between approximately five and nine degrees. In some cases, the tilt angle of the virtual camera may be between approximately five and fifteen degrees (independent of the dental arch).

Optimization of the virtual camera angle may include positioning of the camera so that the patient's entire dental arch is included in the field of view. One approach is to define a bounding box that included all (or substantially all) of the patient's dental arch. The virtual camera may be positioned so that the entire bounding box (and therefore the entire, or substantially all) of the patient's dental arch is within a field of view of the virtual camera.

Next, in block 608, an incisal view of the 3D dental model is generated. The incisal view may refer to a view of the 3D dental model based on the optimized virtual camera position of block 606. In some examples, the incisal view of the 3D dental model may include a relative maximal amount of labial, occlusal, and lingual incisor tooth surfaces. The incisal view may enable the user to determine whether the final position of the patient's teeth according to a dental treatment plan provides acceptable (cosmetic and/or clinical) results.

Next, in block 610, the incisal view of the 3D dental model of the patient's dental arch is displayed. This operation may be optional. In some cases, the incisal view may be shown on a display or user interface for viewing the user's review. In some implementations, the user may decide to modify the patient's treatment plan based on the incisal view of the 3D dental model. In some examples, the displayed incisal view may be based on the optimized virtual camera position of block 606.

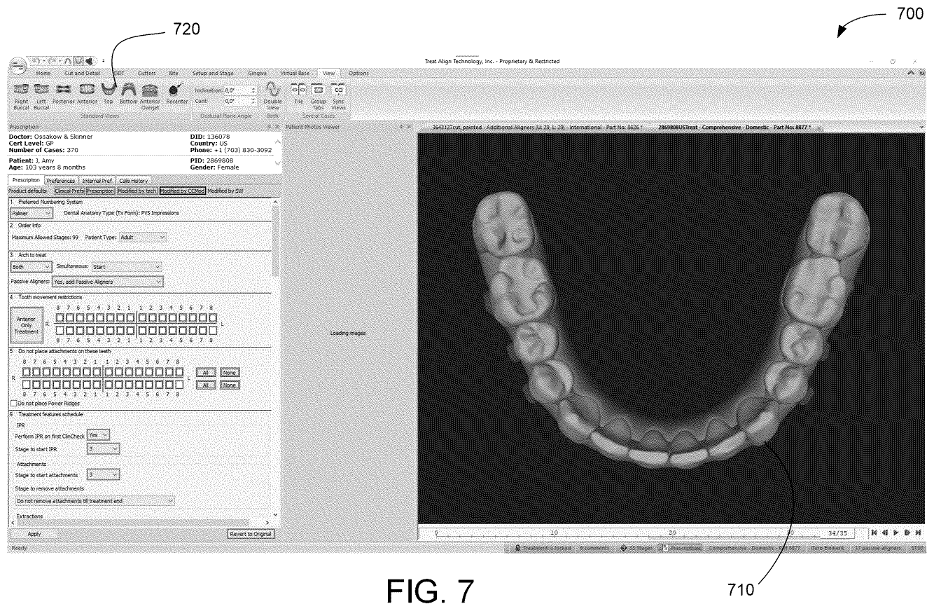

FIG. 7 shows an example user interface 700. The user interface 700 can display a 3D dental model 710. The 3D dental model 710 may be a conventional view or an incisal view of the patient's dental arch that shows the final position of the patient's teeth in accordance with a dental plan. In some examples, the user interface 700 may include a button 720 (or slider or the like) that can toggle between conventional and incisal views.

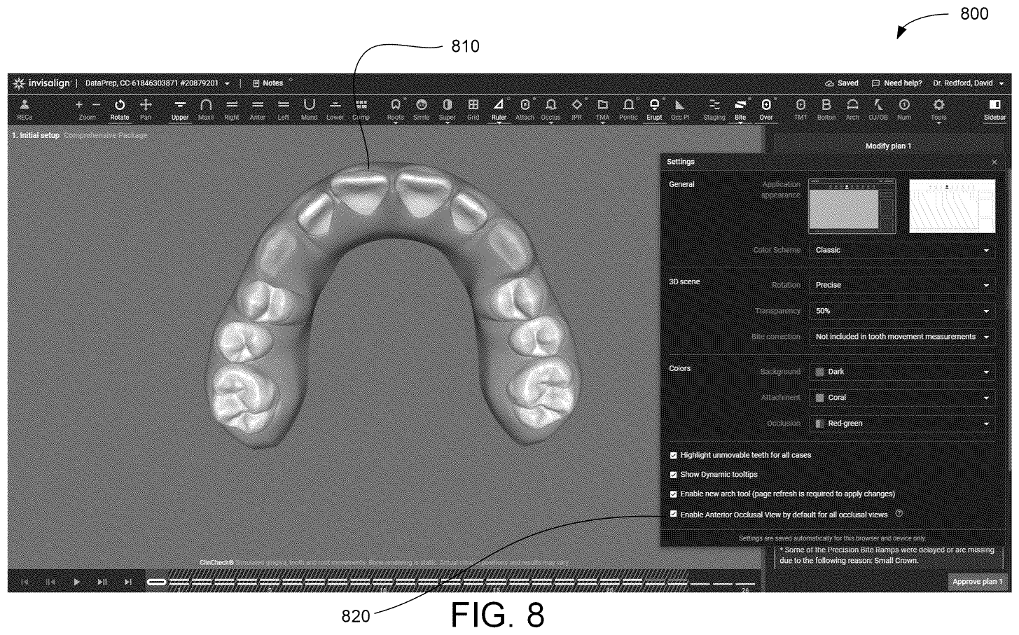

FIG. 8 shows another example user interface 800. The user interface can display a 3D dental model 810. In some examples, the user interface 800 may include a selection button 820 that allows the user to select either conventional or incisal views for the patient's 3D dental model 810.

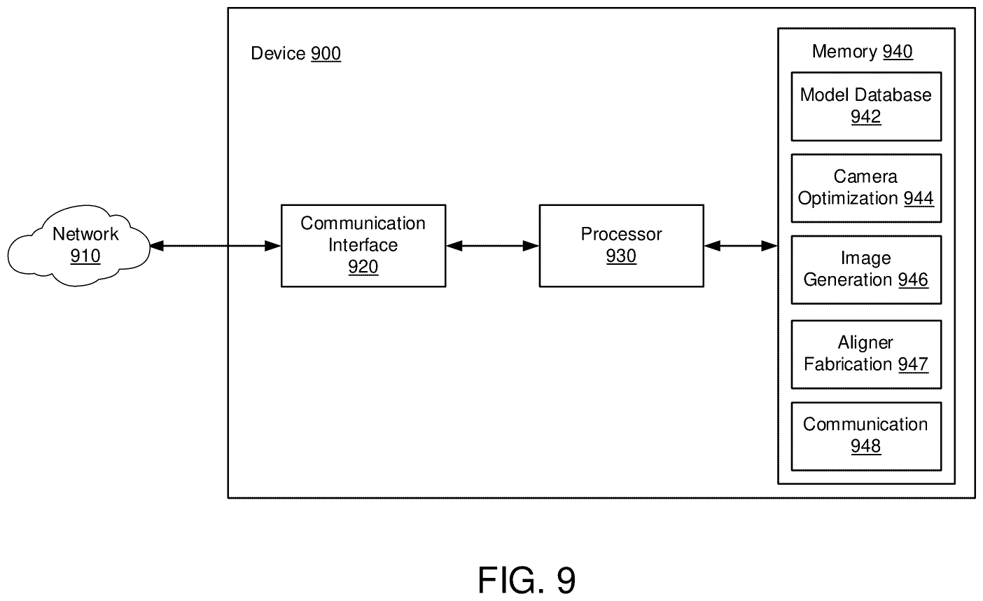

FIG. 9 shows a block diagram of a device 900 that may be one example a device configured to perform one or more operations associated with the computing environment 100 of FIG. 1. The device 900 may include a communication interface 920, a processor 930, and a memory 940.

The communication interface 920, which may be coupled to a network (such as a network 910) and to the processor 930, may transmit signals to and receive signals from other wired or wireless devices, including remote (e.g., cloud-based) storage devices, cameras, processors, compute nodes, processing nodes, computers, mobile devices (e.g., cellular phones, tablet computers and the like) and/or displays. For example, the communication interface 920 may include wired (e.g., serial, ethernet, or the like) and/or wireless (Bluetooth, Wi-Fi, cellular, or the like) transceivers that may communicate with any other feasible device through any feasible network. In some examples, the communication interface 920 may receive previous dental data, current dental data, dental treatment plans, and 3D dental models that are associated with a final position in accordance with a patient's dental treatment plan.

The processor 930, which is also coupled to the memory 940, may be any one or more suitable processors capable of executing scripts or instructions of one or more software programs stored in the device 900 (such as within memory 940).

The memory 940 may include a model database 942 that may be used to locally store 3D dental models for patients. For example, the model database 942 may include one or more 3D dental models for patients that may be based, at least in part, on a dental treatment for that patient. In some cases, the 3D dental models may be received through the communication interface 920 from remote servers, computer nodes, or the like.

The memory 940 may also include a non-transitory computer-readable storage medium (e.g., one or more nonvolatile memory elements, such as EPROM, EEPROM, Flash memory, a hard drive, etc.) that may store the following software modules:
a camera optimization module 944 to determine a position of a virtual camera used to determine a 3D dental image of the patient's dentition;
an image generation module 946 to determine and generate a 3D dental image of the patient's teeth;
an aligner fabrication module 947 to generate dental appliance data in accordance with a dental treatment plan; and
a communication module 948 to transmit and receive data through the communication interface 920.
   Each software module includes program instructions that, when executed by the processor 930, may cause the device 900 to perform the corresponding function(s). Thus, the non-transitory computer-readable storage medium of memory 940 may include instructions for performing all or a portion of the operations described herein.

The processor 930 may execute the camera optimization module 944 to determine and/or optimize the position of a virtual camera. For example, execution of the camera optimization module 944 may obtain 3D dental models (from the model database 942), apply a bounding box to a dental arch included within the 3D dental model, identify incisors included within the dental arch, and position a virtual camera based at least in part on the identified incisors. In some examples, execution of the camera optimization module 944 may enable a view of the 3D dental model that includes a maximal amount of lingual, labial, and occlusal surfaces. In some implementations, execution of the camera optimization module 944 may also tilt the virtual camera toward a central point by a predetermined number of degrees. In some examples, the predetermined number of degrees may be determined by whether the dental arch is an upper or lower dental arch. In general, operations performed through the execution of the camera optimization module 944 may be described herein with respect to FIGS. 5 and 6.

The processor 930 may execute the image generation module 946 to control the generation of images. For example, execution of the image generation module 946 may cause the processor 930 to generate (render) an image of the patient's dentition based on a position of the virtual camera. Execution of image generation module 946 may also cause the display and/or user interface to show views of the patient's teeth and, in some cases, may enable the user to select different views of the patient's teeth. For example, the user may select a conventional or an alternative view of the patient's teeth or dental arch. In some cases, execution of the image generation module 946 can show a view of the incisors having a maximal amount of lingual, labial, and occlusal surfaces.

The processor 930 may execute the aligner fabrication module 947 to generate a patient's dental appliance data. In some examples, the patient's dental appliance data may be determined by the appliance fabrication system 150 of FIG. 1.

The processor 930 may execute the communication module 948 to communicate with any other feasible devices. For example, execution of the communication module 948 may enable the device 900 to communicate via cellular networks conforming to any of the LTE standards promulgated by the 3rd Generation Partnership Project (3GPP) working group, Wi-Fi networks conforming to any of the IEEE 802.11 standards, Bluetooth protocols set forth by the Bluetooth Special Interest Group (SIG), Ethernet protocols, or the like. In some embodiments, execution of the communication module 948 may enable the device 900 to communicate with cloud-based servers, network coupled displays, or other computer devices and/or user interfaces. In some other embodiments, execution of the communication module 948 may implement encryption and/or decryption procedures.

In some cases, a current view of the jaw may ignore the jaw and its objects (teeth, etc.). The line of view is directed along the OZ axis of the scene coordinate system. The line of view goes through the scene center and the distance to the camera is calculated to fit the jaw bounding box width in the field of view. The distance is calculated for the specific viewer. With this approach the camera may be put in a position from where the lingual surfaces of the incisors are not visible. In contrast, a new occlusal view approach (aka Anterior Occlusal View or Incisal View) may consider the jaw incisors when the system calculates the camera position. The pontics and the incisors extracted during the treatment may be disregarded.

In a one approach, the camera may always be placed at where the incisors are directed. This may ensure the proper view at the incisor ridges to help the user to align them. For example, the camera may be placed in the point from of the origin (e.g., the point origin is calculated as the average of the existing incisor positions; the direction of ray origin from is the slightly adjusted average of the individual incisor directions). Alternatively or additionally, the camera may be placed so that the ray is projected at the jaw YOZ plane, and then slightly turned away from OZ axis while remaining in this plane. Alternatively or additionally, the camera may be placed so that the angle of the turn is fixed for a jaw, and it may be, e.g., 10° for the upper and 7° for the lower (these example angels are chosen empirically). As mentioned, the incisors that are pontics or that are extracted during the treatment may be ignored (if there are no relevant incisors, the axis OZ may be used). Alternatively or additionally, the camera may be placed so that the exact position of point from on the ray is chosen to fit the jaw bounding box span in the camera default field of view (e.g., DEFAULT_FOV, now 40°) when the camera directed at the at point (the point at is likely to be the same as the point center of a top/bottom view; the camera may be directed at it and this point may be the center of jaw bounding box). Alternatively or additionally, the camera may be placed so that the up direction may be a vector in YOZ plane that is perpendicular to the ray origin (e.g., from and points at the same half plane as one where OY or OZ point at).

In some cases, the user (e.g., doctor, dentist, technician) may have preferences for Occlusal View. For example, a new occlusal view may be used when the final position is changed in modify mode. This may recalculate an angle for the new occlusal view and apply it for the next click on the new occlusal view.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or clement is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system, comprising:
a processor configured to:
access a three-dimensional (3D) digital model of a patient's upper or lower dental arch;
optimize a virtual camera position relative to the 3D digital model to generate an incisal view having a maximized view of an occlusal surface, a lingual side, and labial side of each incisor in the 3D digital model; and
generate the incisal view of the 3D digital model based on the optimized virtual camera position.

2. The system of claim 1, wherein the processor is configured to optimize the virtual camera position based on a bounding box that surrounds the patient's upper or lower dental arch, wherein the incisal view of the 3D digital model of the patient's dental arch includes all of the bounding box.

3. The system of claim 1, wherein the processor is configured to optimize the virtual camera position based on an average orientation of each incisor in the 3D digital model.

4. The system of claim 3, wherein the processor is further configured to calculate the average orientation of each incisor from an individual orientation of each incisor estimated for each incisor as an axis projected from a root of each incisor.

5. The system of claim 3, wherein the processor is further configured calculate the average orientation of each incisor from an individual orientation of each incisor estimated for each incisor as an axis projected from a center of an incisor to a peak of an occlusal edge of the incisor from the 3D digital model.

6. The system of claim 5, wherein the center of the incisor comprises the center of mass of the incisor from the 3D digital model.

7. The system of claim 1, wherein the processor is configured to optimize the virtual camera position based on an average orientation of each incisor in the 3D digital model.

8. The system of claim 1, wherein the 3D digital model is based on an intraoral scan of the patient's teeth.

9. The system of claim 1, wherein the 3D digital model is based on a segmented intraoral scan of the patient's teeth.

10. The system of claim 1, wherein the 3D digital model comprises a predicted configuration of teeth in accordance with a treatment plan for the patient.

11. The system of claim 1, wherein the processor is further configured to: determine a central point of the patient's dental arch; and tilt the virtual camera toward the central point by a predetermined amount.

12. The system of claim 11, wherein the predetermined amount is between approximately 5 and 15 degrees.

13. The system of claim 11, wherein the predetermined amount is based on whether the dental arch is the patient's upper or lower dental arch.

14. The system of claim 11, wherein the predetermined amount is between about 5-9 degrees when the dental arch is a lower dental arch and between about 9-12 degrees when the dental arch is an upper dental arch.

15. The system of claim 1, wherein the processor is configured to optimize the virtual camera position based on one or more incisors missing from the 3D digital model of the patient's dental arch.

16. The system of claim 1, wherein the processor is further configured to cause the incisal view to be displayed.

17. The system of claim 1, further comprising a user interface configured to detect an incisal view selection input from a user.

18. The system of claim 17, wherein the user interface is configured to display the view of the 3D digital model.

19. The system of claim 17, wherein the detected incisal view selection input comprises a user selecting a virtual control on the user interface.

20. The system of claim 1, wherein the processor is further configured to access the 3D digital model of the patient's upper or lower dental arch in response to a detection of an incisal view selection input.

21. A non-transitory computer-readable storage medium comprising instructions that, when executed by one or more processors of a device, cause the device to perform operations comprising:
accessing, in response to a user incisal view selection input, a three-dimensional (3D) digital model of a patient's upper or lower dental arch;
optimizing a virtual camera position relative to the 3D digital model to generate an incisal view having a maximized view of a occlusal surface, a lingual side and labial side of each incisor in the 3D digital model; and
generating the incisal view of the 3D digital model based on the optimized virtual camera position.

22. A method, the method comprising:
accessing a three-dimensional (3D) digital model of a patient's upper or lower dental arch;
optimizing a virtual camera position relative to a, a three-dimensional (3D) digital model of a patient's dental arch to generate an incisal view having a maximized view of an occlusal surface, a lingual side and labial side of each incisor in the 3D digital model; and
generating the incisal view of the 3D digital model based on the optimized virtual camera position.
